(19) United States
(12) Patent Application Publication
(10) Pub. No.: US 2013/0289454 A1
(43) Pub. Date: Oct. 31, 2013

(54) Waist massager for walking or jogging

(71) Applicants: WEI-CHEN WANG, Taichung City (TW); CHUN-HSIEN WU, Tainan City (TW)

(72) Inventors: WEI-CHEN WANG, Taichung City (TW); CHUN-HSIEN WU, Tainan City (TW)

(21) Appl. No.: 13/459,083

(22) Filed: Apr. 28, 2012

(51) Int. Cl. A61H 15/00

(52) U.S. Cl. 601/132

(57) ABSTRACT

The waist massager includes an annular massage assembly and a grip assembly. The annular massage assembly is composed of a ring body with a plurality of roller sets arranged on an inside thereof. The grip assembly is connected to the annular massage assembly to be able to push and pull the roller sets transversely.

### BACKGROUND OF THE INVENTION

1. Technical Field

The invention relates to health caring equipment, particularly to waist massagers for walking or jogging.

2. Related Art

For many people, it is a big problem to find a suitable and available exercise. Walking and jogging has become a popular manner of exercise.

However, pure walking or jogging can only obtain a limited effect. There is no equipment used for walking or jogging in the market. There is no equipment for detecting users' health status in the market. And there is no equipment used in dark or low light situations.

### SUMMARY OF THE INVENTION

An object of the invention is to provide a waist massager, which can massage a user's waist when he/she is walking or jogging.

To accomplish the above object, the waist massager of the invention includes an annular massage assembly and a grip assembly. The annular massage assembly is composed of a ring body with a plurality of roller sets arranged on an inside thereof. The grip assembly is connected to the annular massage assembly to be able to push and pull the roller sets transversely.

Also, the invention has advantages as follows:

1) The waist massager of the invention is worn on the waist of a walker or jogger, so that the walker or jogger may hold the grips to rotate horizontally. As a result, the walker's or jogger's waist is massaged by the surrounding roller sets.

2) The roller sets which can rotate 360 degrees may achieve a relaxative and warm-up effect to the walker or jogger to avoid possible injuries.

3) The waist massager is further provided with an electronic watch. The watch has a display for showing time, calorie, distance and heart rate. Additionally, the watch will alarm the user when he/her heart rate is overhigh.

4) The waist massager is further provided with an LED lamp to provide a safety effect when the user is using the massager in a dark or low light situation.

### BRIEF DESCRIPTION OF THE DRAWINGS

FIG. 1 is an exploded view of the invention;

FIG. 2 is a perspective view of the invention;

FIG. 3 is a perspective view of the invention with L-shaped handles;

FIG. 4 is a schematic view showing the LED lamp is lighting up;

FIG. 5 is a top view of the invention;

FIG. 6 shows a user wearing the invention to move vertically;

FIG. 7 shows a user wearing the invention is walking; and

FIG. 8 shows a user wearing the invention is jogging.

### DETAILED DESCRIPTION OF THE INVENTION

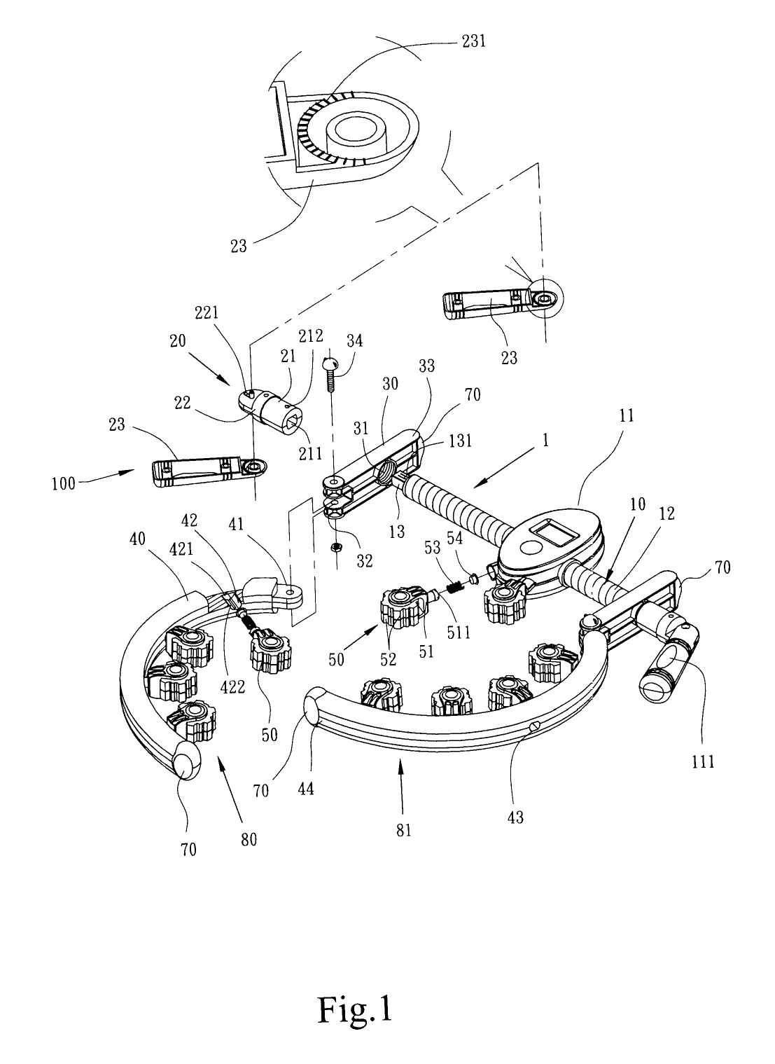

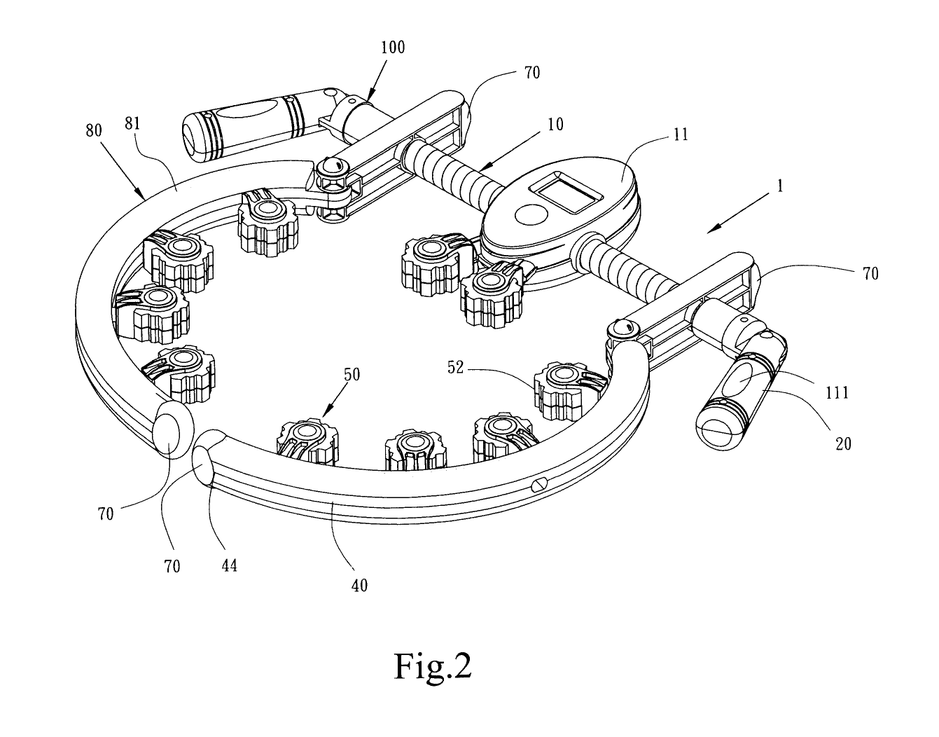

Please refer to FIGS. 1 and 2. The waist massager of the invention includes an annular massage assembly 80 and a grip assembly 100. The annular massage assembly 80 is composed of a ring body 81 with a plurality of roller sets 50 arranged on an inside thereof. The grip assembly 100 is connected to the annular massage assembly 80 to be able to push and pull the roller sets 50 transversely so that the roller sets 50 can press or massage a user's waist.

The grip assembly 100 includes a front rod 10, two grips 20 and two connectors 30. An electronic watch 11 is fastened on the front rod 10. The front rod 10 is provided with an outer thread 12 and two connecting blocks 13 at two ends thereof. Each of the grips 20 includes a grip member 23, a first portion 21 and a second portion 22. The connecting block 13 is received in the trough 211 in the first portion 21. The connecting block 13 is provided with a retractable positioning ball 131 to be embedded into a hole 212 for positioning. The grip member 23 is pivotally connected to the second portion 22. A multi-sectional positioning mechanism with a 180-degree range is provided between the grip member 23 and the second portion 22. The multi-sectional positioning mechanism includes a retractable ball 221 and a series of teeth 231 in a semicircular arrangement. The second portion 22 is pivotally connected to the first portion 21 and a multi-sectional positioning mechanism with a 360-degree range is provided between the first and second portions 21, 22. The connectors 30 are separately provided with inner threads 31 to screw the outer thread 12 and the distance between the connectors 30 may be adjusted by rotating the connectors 30 for matching users with different waist sizes.

The ring body 81 is composed of two arcked rods 40. An end of each of the connectors 30 is pivotally connected to a front end 41 of each of the arcked rods 40. The two arcked rods 40 substantially form a ring. Each of the roller sets 50 is formed with protrusions 511. The electronic watch 11 and the arcked rods 40 are provided with fixing holes 42 for connecting the roller sets 50. Each of the fixing holes 42 is formed with a rotating trough 421 and four guiding slots 422. The roller sets 50 can be set into a horizontal mode or a vertical mode. Each of the roller sets 50 is composed of a bracket 51 and two rollers 52. The bracket 51 is further disposed with a spring 53 and a cap 54, which are received in the fixing hole 42. Thus the roller sets 50 can normally protrude from the arcked rods 40 and trend the center of the arcked rods 40. A user may hold the grips 20 to sway the arcked rods 40 and make the roller sets 50 flexibly press his/her waist.

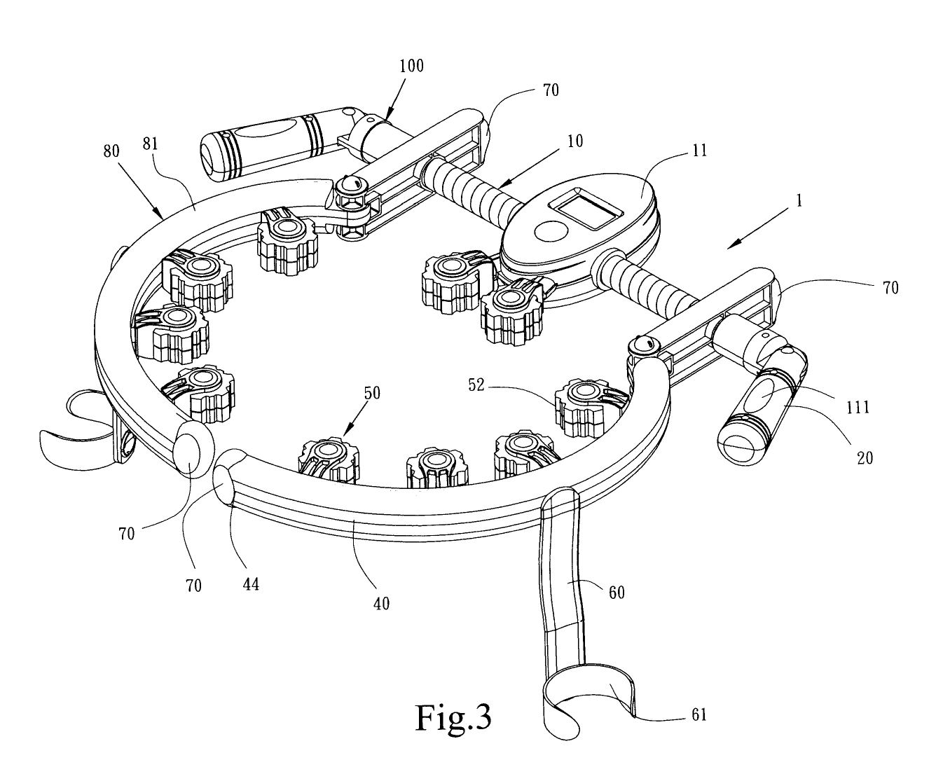

Each of the arcked rods 40 is provided with an assembling hole 43 for connecting an L-shaped handle 60 with an insert. An outer end of the L-shaped handle 60 is provided with a C-shaped frame 61 for hitching a user's arm. A user may sway the arcked rods 40 by swinging his/her arms hitched in the C-shaped frames 61. The L-shaped handle 60 is selective to be installed or removed as shown in FIGS. 2 and 3.

The roller sets 50 may be rotated 360 degrees. A user's waist can be relaxed and warmed up by reciprocating or swaying the roller sets 50 to avoid injuries.

The waist massager can help an overweight user to effectively consume calories. A jogger may hold the grips 20 to sway the roller sets 50 to massage his/her waist. A walker may hold the L-shaped handles 60 with C-shaped frames 61 and naturally sway to massage his/her waist.

The waist massager 1 is further provided with an electronic watch 11 with a sensor electrically connected to the grips 20. Body conditions of a user can be transmitted from the grips 20 to the electronic watch 11 when the user is holding the grips 20. The electronic watch 11 also has a USB receptacle, an MP3 player, a display for showing time, calories, distance and heart rate. And the electronic watch may make an alert to the user when his/her heart rate is overhigh.

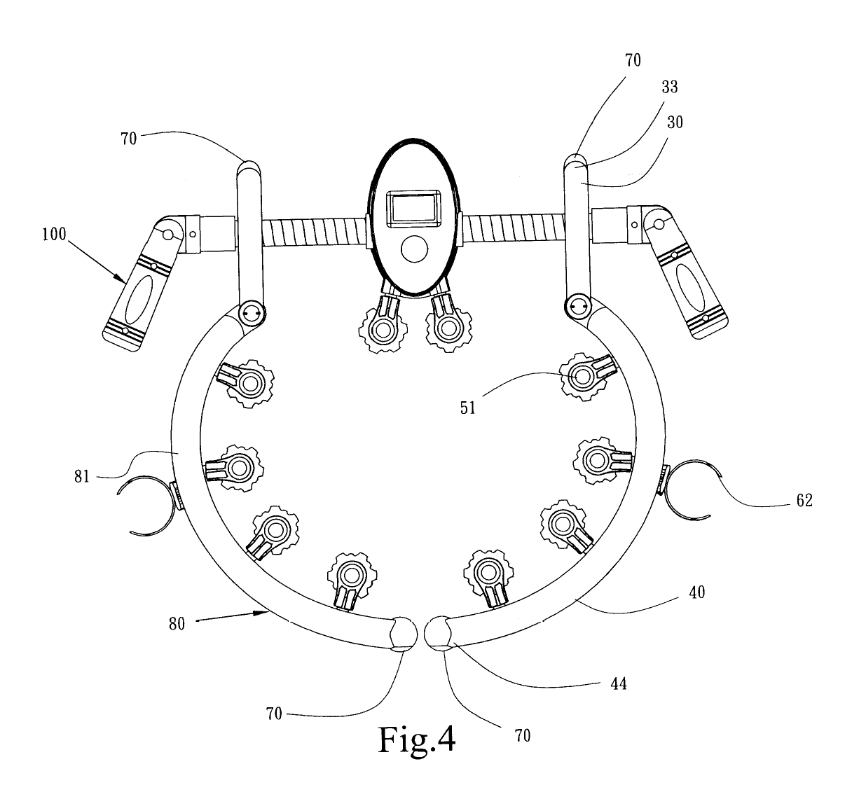

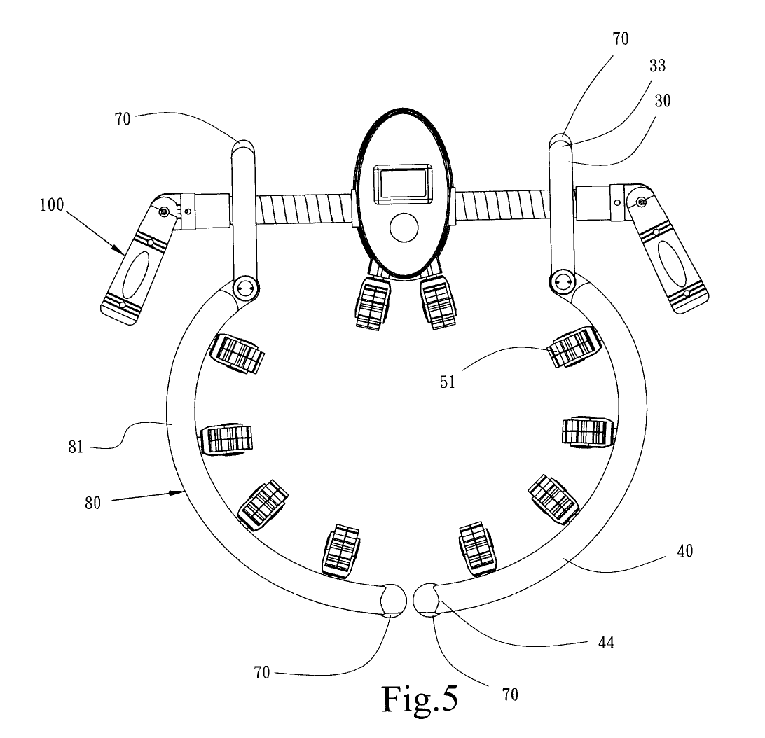

Please refer to FIGS. 4 and 5. When the rollers 52 are pressed to compress the spring 53 and turned 90 degrees, the rollers 52 can be automatically positioned at a horizontal or vertical position. A front end 33 of each of the connectors 30 and a distal end 44 of each of the arcked rods 40 may be further provided with an LED lamp 70 or reflector. The LED lamps 70 make the user noted by others to achieve a safety effect when the user is in a dark or low light situation.

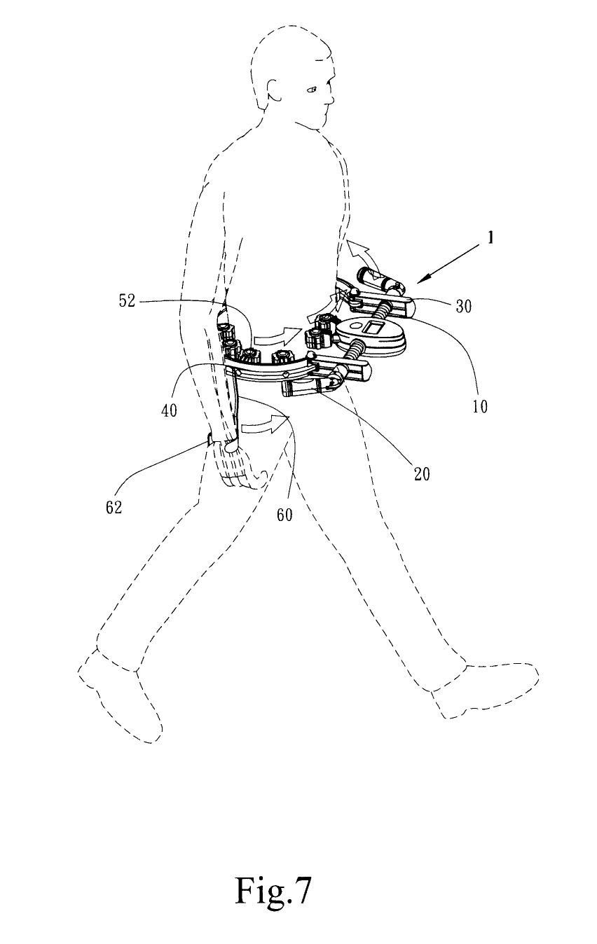

Please refer to FIG. 7. The connectors 30 may be adjusted to fit the body shape of a user. After that, the arcked rods 40 and grips 20 are connected. The arcked rods 40 may be connected to the L-shaped handles 60. The L-shaped handles 60 may be adjusted to fit the body length of a user. When wearing the waist massager 1, a user who is walking may put his/her arms in the L-shaped handles 60 and naturally sway his/her hands to sway the arcked rods 40 with the rollers 52 to massage his/her waist by the pressure from the springs 53. Thus a massage effect can be obtained when walking.

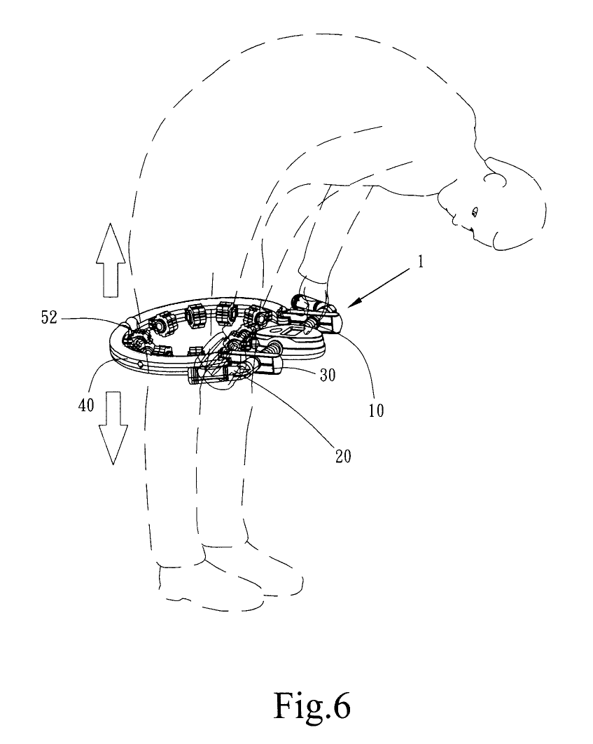

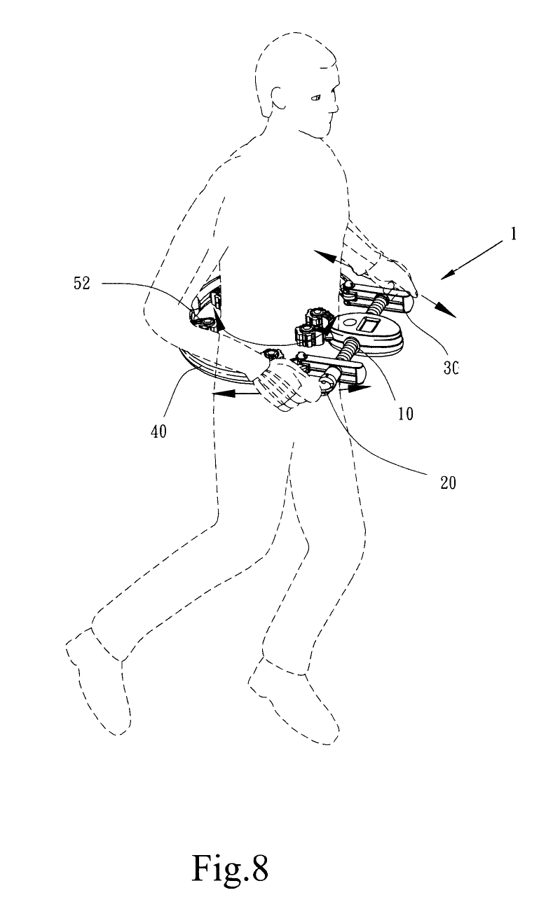

Please refer to FIGS. 6 and 8. The waist massager 1 may be used to warm up before jogging or to massage muscle after exercise. To accomplish this function, the waist massager 1 must be moved upwards and downwards. The connectors 30 may be adjusted to fit the body shape of a user. After that, the arcked rods 40 and grips 20 are connected. When wearing the waist massager 1, a user may turn the rollers 52 into a vertical direction, hold the grips 20 and move upwards and downwards.

It will be appreciated by persons skilled in the art that the above embodiment has been described by way of example only and not in any limitative sense, and that various alterations and modifications are possible without departure from the scope of the invention as defined by the appended claims.

What is claimed is:

1. A waist massager comprising:
an annular massage assembly composed of a ring body with a plurality of roller sets arranged on an inside thereof; and
a grip assembly, connected to the annular massage assembly to be able to push and pull the roller sets transversely.

2. The waist massager of claim 1, wherein the grip assembly comprises:
a front rod, having an outer thread screwing inner threads of two connectors and two connecting blocks at two ends thereof; and
two grips, each having a grip member, a first portion and a second portion, the connecting block being received in the trough in the first portion, the connecting block being provided with a retractable positioning ball to be embedded into a hole for positioning, the grip member being pivotally connected to the second portion, a multi-sectional positioning mechanism with a 180-degree range being provided between the grip member and the second portion, the multi-sectional positioning mechanism including a retractable ball and a series of teeth in a semicircular arrangement, the second portion being pivotally connected to the first portion, and a multi-sectional positioning mechanism with a 360-degree range being provided between the first and second portions.

3. The waist massager of claim 2, wherein the ring body is composed of two arcked rods, an end of each of the connectors is pivotally connected to a front end of each of the arcked rods, the arcked rods are disposed with the roller sets, the arcked rods are provided with fixing holes for connecting some of the roller sets, each of the fixing holes is formed with a rotating trough and four guiding slots, each of the roller sets is composed of a bracket and two rollers, the bracket is further disposed with a spring and a cap, which are received in the fixing hole, and the roller sets normally protrude from the arcked rods.

4. The waist massager of claim 3, further comprising an electronic watch fastened on the front rod, wherein the electronic watch is provided with fixing holes for connecting the other roller sets, body conditions of a user can be transmitted from the grips to the electronic watch when the user is holding the grips, the electronic watch further has a display for showing time, calories, distance and heart rate, and the electronic watch makes an alert to the user when his/her heart rate is overhigh.

5. The waist massager of claim 3, wherein each of the arcked rods is provided with an assembling hole for connecting an L-shaped handle with an insert, an outer end of the L-shaped handle is provided with a C-shaped frame for hitching a user's arm.

6. The waist massager of claim 5, wherein the L-shaped handle is removably connected to the arcked rods.

7. The waist massager of claim 3, wherein a front end of each of the connectors is provided with an LED (light emitting diode) lamp.

8. The waist massager of claim 3, wherein a front end of each of the connectors is provided with a reflector.

9. The waist massager of claim 3, wherein the grips are of an angle-adjustable type.

10. The waist massager of claim 3, wherein the two arcked rods substantially form a ring.
